(19) United States
(12) Patent Application Publication
(10) Pub. No.: US 2025/0329152 A1
(43) Pub. Date: Oct. 23, 2025

(54) METHOD, SYSTEM AND ELECTRONIC DEVICE FOR DETECTING WEEDS IN FARMLAND

(71) Applicant: DALIAN UNIVERSITY, Dalian (CN)

(72) Inventors: Yuanming DING, Dalian (CN); Lin SONG, Dalian (CN); Chen JIANG, Dalian (CN); Ran ZHANG, Dalian (CN)

(73) Assignee: DALIAN UNIVERSITY, Dalian (CN)

(21) Appl. No.: 18/800,155

(22) Filed: Aug. 12, 2024

Related U.S. Application Data
(63) Continuation of application No. PCT/CN2024/096052, filed on May 29, 2024.

(30) Foreign Application Priority Data
Apr. 22, 2024 (CN) 202410488772.8

(51) Int. Cl. G06V 10/82; A01M 21/00; G06V 10/766; G06V 10/77; G06V 10/80; G06V 20/10

(52) U.S. Cl. CPC G06V 10/82; A01M 21/00; G06V 10/766; G06V 10/7715; G06V 10/806; G06V 20/188

(57) ABSTRACT

A method, a system and an electronic device for detecting weeds in farmland are provided, wherein the method includes: collecting a target image of weeds in farmland; constructing a weed detection model by using YOLOv8 based on a RevColNet backbone network, and identifying weeds based on the weed detection model; accurately removing the weeds. The method is used for solving the defects that: when identifying weeds in farmland, all kinds of information of weeds cannot be well described, it is difficult to obtain high identification accuracy, and problems such as high computational complexity, large model parameters, large model scale and the like are faced. The method and the system provide an improved model based on YOLOv8, which can identify weeds in farmland with higher accuracy, with lower computational complexity, and higher weed identification efficiency.

### CROSS REFERENCE TO THE RELATED APPLICATIONS

This application is a continuation application of International Application No. PCT/CN2024/096052, filed on May 29, 2024, which is based upon and claims priority to Chinese Patent Application No. 202410488772.8, filed on Apr. 22, 2024, the entire contents of which are incorporated herein by reference.

### TECHNICAL FIELD

The disclosure relates to the technical field of image recognition, in particular to a method, a system and an electronic device for detecting weeds in farmland.

### BACKGROUND

Weed removal is one of the most important tasks in agricultural production. Weeds have tenacious vitality, which has a great impact on crop yield and quality by competing with crops for resources such as nutrition, water and light. According to statistics, the annual grain loss caused by weeds in the field is about 13.2%, which is equivalent to the annual rations of 1 billion people.

At present, the method of weed removal is mainly accomplished by spraying herbicides on a large area. This indiscriminate spraying method will leave a lot of pesticides on crops, which will not only affect the normal growth of crops, but also cause certain damage to the ecological environment in the field.

Accurate identification of weeds in the field and accurate weeding play a great role in improving crop yield and reducing the ecological harm caused by pesticides. Therefore, the weeding robot, which can accurately identify all kinds of weeds and remove them, is gradually developed. It realizes intelligent weeding and plays an important role in improving crop yield and reducing the impact of pesticides on the environment. The traditional method for detecting weeds in farmland mainly rely on artificially designed texture, shape and other characteristics, and realize the detection target by using wavelet analysis, Bayesian discriminant model, support vector machine and other methods. Because the characteristics of artificial design cannot well summarize all kinds of information of weeds, it is difficult to obtain high recognition accuracy on complex data sets by using these methods.

In addition, the calculation and storage resources of the core processing equipment of weeding robot are limited. Aiming at the problems of high calculation complexity, large model parameters and large model scale of weeding robot at present, it is urgent to reduce the model parameters and calculation complexity while ensuring the recognition accuracy.

### SUMMARY

The disclosure provides a method, a system and an electronic device for detecting weeds in farmland, which are used for solving the defects that in the prior art, when identifying weeds in farmland, all kinds of information of weeds cannot be well described, it is difficult to obtain high identification accuracy, and problems such as high computational complexity, a large number of model parameters, a large model scale and the like are faced.

The disclosure provides a method for detecting weeds in farmland, including:
collecting a target image of weeds in farmland;
constructing a weed detection model by using YOLOv8 based on a RevColNet backbone network, and identifying weeds based on the weed detection model;
accurately removing the weeds.

According to the method for detecting weeds in farmland provided by the disclosure, wherein using YOLOv8 based on a RevColNet backbone network to construct a weed detection model includes:
reconstructing a backbone network of YOLOv8 based on the RevColNet, and obtaining a backbone network RevCol;
introducing a fused dilation-wise residual module to improve a recognition ability of occluded targets;
introducing a GSConv module and a VoV-GSCSPC module that are based on deep separable convolution to lighten the model;
improving a bounding box regression loss function of YOLOv8 model based on a minimum point distance.

According to the method for detecting weeds in farmland provided by the disclosure, wherein the backbone network RevCol includes a plurality of columns, each column represents an input, a starting position of each column contains a low-level detail information, and with the compression of image channels, a high-level semantic information is extracted at an end position of each column; a reversible connection design is adopted between columns to ensure that information is transmitted between columns without loss, and a supervision is added at the end position of each column to constrain a feature extraction of each column.

According to the method for detecting weeds in farmland provided by the disclosure, wherein the fused dilation-wise residual module is used for:
performing a 3×3 standard convolution operation on the data input into the weed detection model, and extracting features through batch normalization and activation by using an activation function;
after the 3×3 standard convolution operation, obtaining a semantic residual through a BN layer;
connecting all branches to characteristic graphs, merging all the characteristic graphs by pointwise convolution, and generating a final residual corresponding to the data input into the weed detection model;
fusing the final residual with the input data to construct a final feature representation.

According to the method for detecting weeds in farmland provided by the disclosure, wherein the fused dilation-wise residual module is provided with a plurality of channels, and a number of convolution channels with the lowest void rate is set to be twice that of other channels.

According to the method for detecting weeds in farmland provided by the disclosure, wherein the GSConv module is used for:
based on a number of input channels, obtaining a number of first output channels by standard convolution;
based on the number of first output channels, obtaining a number of second output channels by deep separable convolution;
connecting and shuffling the number of first output channels and the number of second output channels to obtain a number of output channels.

According to the method for detecting weeds in farmland provided by the disclosure, wherein improving a bounding box regression loss function of YOLOv8 model based on a minimum point distance includes:
determining a similarity between a predicted bounding box and an actual labeled bounding box in a process of bounding box regression, and calculating a key point distance between the predicted bounding box and the actual labeled bounding box based on the similarity, so as to improve an accuracy of loss measurement.

According to the method for detecting weeds in farmland provided by the disclosure, wherein improving a bounding box regression loss function of YOLOv8 model includes:
introducing a scale factor “ratio” to control a size of an auxiliary frame to calculate a loss;
when a value of ratio is set to be greater than 1, generating a larger scale auxiliary frame relative to the actual frame to calculate the loss;
when the value of ratio is set to less than 1, generating a smaller scale auxiliary frame to calculate the loss, so that an absolute value of a regression gradient is greater than that of an actual frame IoU gradient.

The disclosure further provides a system for detecting weeds in farmland, including:
an image acquisition module, configured for collecting a target image of weeds in farmland;
a weed identification module, configured for constructing a weed detection model by using YOLOv8 based on a RevColNet backbone network, and identifying weeds based on the weed detection model;
a weed removing module, configured for accurately removing the weeds.

The disclosure further provides an electronic device, which includes a memory, a processor, and a computer program stored in the memory and executable on the processor, wherein when the processor executes the program, any of the above-mentioned methods for detecting weeds in farmland is realized.

The disclosure also provides a non-transient computer-readable storage medium, on which a computer program is stored, and when the processor executes the computer program, any of the above-mentioned methods for detecting weeds in farmland is realized.

The disclosure also provides a computer program product, which includes a computer program, and and when the processor executes the computer program, any of the above-mentioned methods for detecting weeds in farmland is realized.

In the technical solution of the disclosure, the backbone network of YOLOv8 is reconstructed based on RevColNet, which can reduce the computational complexity and parameter quantity of the model and improve the ability of extracting features of the model. When the improved weed detection model is applied to weed identification, weeds in farmland can be identified with higher accuracy, with lower computational complexity and higher efficiency of weed identification.

### BRIEF DESCRIPTION OF THE DRAWINGS

In order to explain the technical solutions of the present disclosure or the prior art more clearly, the drawings needed in the embodiments or the prior art will be briefly introduced below. Obviously, the drawings in the following description are some embodiments of the present disclosure, and other drawings can be obtained according to these drawings without creative work for ordinary skills in the art.

FIG. 1 is a flow diagram of a method for detecting weeds in farmland provided by an embodiment of the present disclosure;

FIG. 2 is a first structural schematic diagram of the weed detection model provided by an embodiment of the present disclosure;

FIG. 3 is a second schematic structural diagram of the weed detection model provided by an embodiment of the present disclosure;

FIG. 4 is a third structural schematic diagram of the weed detection model provided by an embodiment of the present disclosure;

FIG. 5 is a fourth structural schematic diagram of the weed detection model provided by an embodiment of the present disclosure;

FIG. 6 is a fifth structural schematic diagram of the weed detection model provided by an embodiment of the present disclosure;

FIG. 7 is a sixth structural schematic diagram of the weed detection model provided by an embodiment of the present disclosure;

FIG. 8 is a seventh structural schematic diagram of the weed detection model provided by an embodiment of the present disclosure;

FIG. 9 is an eighth structural schematic diagram of the weed detection model provided by an embodiment of the present disclosure;

FIG. 10 is a schematic structural diagram of a system for detecting weeds in farmland provided by an embodiment of the present disclosure;

FIG. 11 is a schematic diagram of the physical structure of an electronic device provided by an embodiment of the present disclosure.

### DETAILED DESCRIPTION OF THE EMBODIMENTS

In order to make the object, technical solution and advantages of the present disclosure more clear, the technical solution in the present disclosure will be described clearly and completely with reference to the attached drawings. Obviously, the described embodiments are part of the embodiments of the present disclosure, but not all of them. Based on the embodiments in the present disclosure, all other embodiments obtained by ordinary skills in the art without creative work belong to the scope of protection of the present disclosure.

With the rapid development of computer technology, convolutional neural network has achieved good results in weed identification. In recent years, YOLO series of deep learning models have been widely used in the field of target recognition, and achieved better performance than other models in many visual tasks, so some scholars began to apply YOLO series models to the field of agricultural recognition. Among them, Donghui et al. used embedded SA module in the feature extraction part to optimize the feature extraction ability of YOLOv4 model, and improved the detection accuracy by optimizing the detection head. Guo Baizhang et al. put forward an improved YOLOv5 model with attention mechanism, and used random gradient descent in model training to realize accurate identification when weeds and crops have high similarity. The latest detection model YOLOv8 achieves 92.1% for mAP50 and 62.3% for mAP50-95 on weed25 data set.

Through analysis, although the detection accuracy of various models currently used for identification has achieved good results, the calculation and storage resources of the core processing equipment of weeding robot are limited, so it still faces problems such as high computational complexity, large model parameters and large model scale. In the case of ensuring the identification accuracy, further research is needed to reduce the model parameters and computational complexity for weed identification. Therefore, the disclosure proposes an improved model based on the newly developed YOLOv8. An improved device is fixed to the vision module of the weeding robot for real-time scanning and detection, and the weed coordinates are returned by the positioning module to achieve accurate weeding.

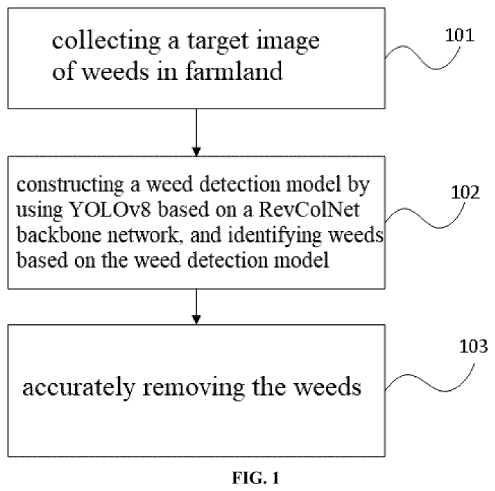

FIG. 1 is a flow diagram of a method for detecting weeds in farmland provided by an embodiment of the present disclosure.

As shown in FIG. 1, this embodiment provides a method for detecting weeds in farmland, including:
Step 101, collecting a target image of weeds in farmland;
Step 102, constructing a weed detection model by using YOLOv8 based on a RevColNet backbone network, and identifying weeds based on the weed detection model;
Step 103, accurately removing the weeds.

YOLOv8 is a commonly used model for object detection, but there are still many problems in YOLOv8 model, such as: small target labeling frames has low resolution, and is densely distributed and easy overlapping; small target detection is easily disturbed by image background and noise; the classification and location loss of small targets is difficult to calculate. In view of this, the conventional YOLOv8 model can't meet the task of weed detection. Therefore, the conventional YOLOv8 model is improved in the application based on RevColNet, which not only reduces the computational complexity and parameter quantity of the model, but also improves the model's ability to extract features.

In practice, at present, the backbone of YOLO series models is a top-down structure. In the process of feature extraction, the information contained in the image will be lost to some extent, and the performance of the model will also be lost. In this application, Revcolnet (Reversible Column Networks) is a reversible multi-column network with a multi-column structure.

In practical application, in step 103, weeds are accurately removed, specifically, the position of weeds can be accurately located by the coordinates, and the weeding robot is controlled to remove weeds, that is to say, the weed detection model provided in this embodiment can finally output the coordinates of weeds in the target image of farmland.

In an exemplary embodiment, using YOLOv8 based on a RevColNet backbone network to construct a weed detection model includes:
reconstructing a backbone network of YOLOv8 based on the RevColNet, and obtaining a backbone network RevCol;
introducing a fused dilation-wise residual module to improve a recognition ability of occluded targets;
introducing a GSConv module and a VoV-GSCSPC module that are based on deep separable convolution to lighten the model;
improving a bounding box regression loss function of YOLOv8 model based on a minimum point distance.

The embodiment has the following beneficial effects:

By redesigning the backbone of YOLOv8, the multi-scale fusion of feature information in different levels is strengthened, and the computational complexity and parameters of the model are significantly reduced by limiting the number of columns of RevCol.

The introduction of the fused dilation-wise residual module can help the model to fuse different levels of features more effectively and improve the detection accuracy of the model.

By introducing GSConv and VoVGSCSPC modules, the parameters and scale of the model are greatly reduced while ensuring the detection accuracy and generalization ability of the model.

The bounding box regression loss function provided by this embodiment not only includes all relevant factors considered in the existing loss function, such as, overlapping or non-overlapping areas, center distance and the deviation of width and height, but also simplifies the calculation process. On this basis, the bounding box regression loss function obtained by further improvement is helpful to the regression of samples by using auxiliary borders to calculate losses, and the final bounding box regression loss function effectively improves the detection accuracy of the model.

In an exemplary embodiment, the backbone network RevCol includes a plurality of columns, each column represents an input, a starting position of each column contains a low-level detail information, and with the compression of image channels, a high-level semantic information is extracted at an end position of each column; a reversible connection design is adopted between columns to ensure that information is transmitted between columns without loss, and a supervision is added at the end position of each column to constrain a feature extraction of each column.

In practice, low-level detail information can be expressed by low-level information, which usually refers to some small detail information in an image, such as edge, corner, color, pixeles, gradients, etc., these information can be obtained by filters, SIFT or HOG.

High-level semantic information can be expressed by feature, which is built on the low-level and can be used to identify and detect the object or the shape of the object in an image. It is rich in semantic information, which can be understood as information obtained by synthesizing a series of information such as environmental information and texture information, and can be used for subsequent classification or detection.

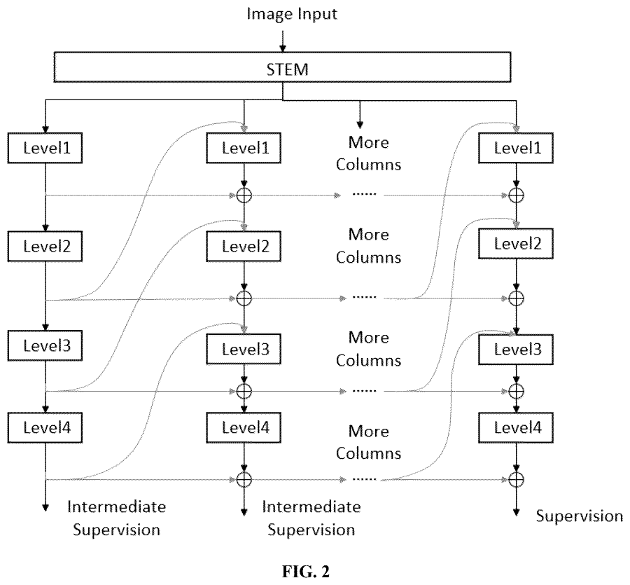

FIG. 2 is a first structural schematic diagram of the weed detection model provided by an embodiment of the present disclosure.

FIG. 2 illustrates the macro structure of RevColNet used in the application. As shown in FIG. 2, RevColNet adopts multi-input design, and the starting position of each column contains low-level information. With the compression of the image channel, the semantic information in the feature is extracted at the end of the column. The Reversible connection design between columns ensures that information is lossless when transmitted between columns, and at the same time, supervision is added at the end of each column to constrain the feature extraction of each column.

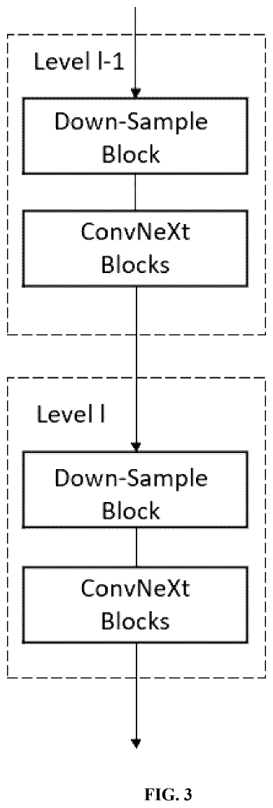

FIG. 3 is a second structural schematic diagram of the weed detection model provided by an embodiment of the present disclosure.

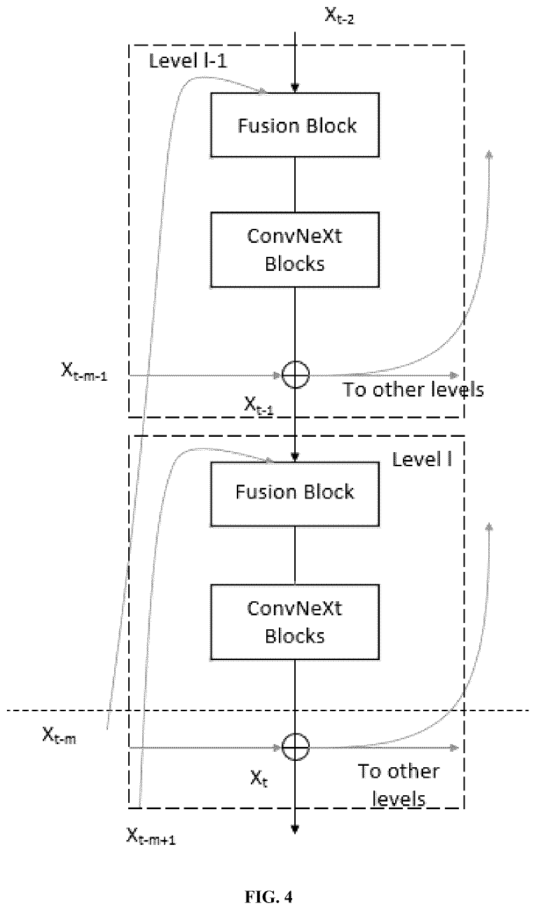

FIG. 4 is a third structural schematic diagram of the weed detection model provided by an embodiment of the present disclosure.

FIGS. 3 and 4 illustrate the microstructure of RevColNet used in the present application, in which each level module in FIG. 3 shows performs feature extraction through downsampling and ConvNeXt, and FIG. 4 shows the Reversible connection design between column.

In practical application, the Reversible connection design between column in FIG. 4 conforms to how to calculate Formula (1) and Formula (2):

$$Xt = Ft ( Xt - 1 , Xt - m + 1 ) + ℽ Xt - m \qquad ( 1 )$$

$$Xt - m = {ℽ}^{- 1} [ Xt - Ft ( Xt - 1 , Xt - m + 1 ) ] \qquad ( 2 )$$

Wherein Formula (1) shows the interaction between each level in the second column, and the output Xₜ is determined by three inputs. The output of the previous level is Xₜ₋₁, and the output of the next level of the previous column is Xₜ₋ₘ₊₁. The two outputs are consistent with the output of the previous column Xₜ₋ₘ by adjusting shape through Fₜ operation, in which Fₜ( ) operation includes a fusion module and n convolution modules. Finally, the obtained features are added with γ times Xₜ₋ₘ, Formula (2) shows the reversibility of the network and ensures the lossless information transmission.

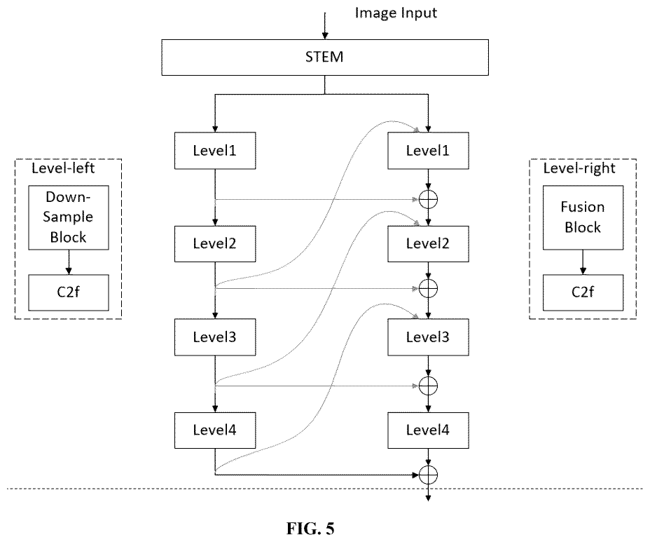

FIG. 5 is a fourth structural diagram of the weed detection model provided by an embodiment of the present disclosure.

FIG. 5 illustrates the structure of a reconstructed backbone network RevCol.

As shown in FIG. 5, in order to avoid the increase of the complexity and parameters of the model caused by the overstaffed backbone network, the number of columns of RevCol may be set to 2, and the operations in the feature fusion block can be reconstructed at the same time. For high-level semantic information, only one composite operation is performed to realize down-sampling, namely convolution, batch normalization and activation function. For low-level detail information, convolution combined with up-sampling is used to replace the original up-sampling operation, and C2f block of YOLOv8 is used to replace ConvNeXt block in level.

In practical application, the above-mentioned feature fusion block module is a module in the backbone network, which adjusts the feature channels with different input sizes into the same output size.

In an exemplary embodiment, the fused dilation-wise residual module is used for:
performing a 3×3 standard convolution operation on the data input into the weed detection model, and extracting features through batch normalization and activation by using an activation function;
after the 3×3 standard convolution operation, obtaining a semantic residual through a BN layer;
connecting all branches to characteristic graphs, merging all the characteristic graphs by pointwise convolution, and generating a final residual corresponding to the data input into the weed detection model;
fusing the final residual with the input data to construct a final feature representation.

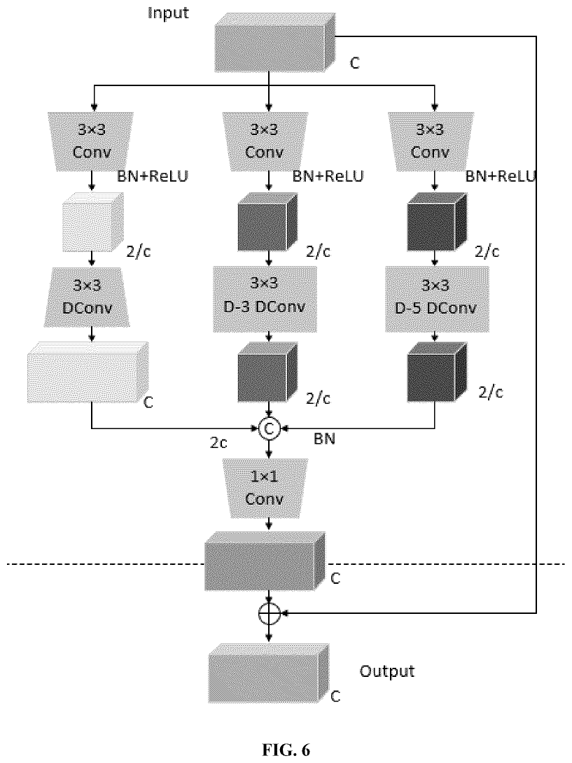

FIG. 6 is a fifth structural schematic diagram of the weed detection model provided by an embodiment of the present disclosure.

In practical application, due to the multi-scale characteristics, the traditional YOLO series model has poor recognition effect on occluded targets, is easy to make wrong classification, and also has some shortcomings in small target detection. Therefore, this disclosure introduces a fused dilation-wise residual (DWR) module, which is applied to the deep layer of the network, and the multi-branch structure is used to meet the needs of different sizes of receptive fields in a layer. Its structure is shown in FIG. 6. For the input feature map, firstly, the standard convolution operation of 3×3 kernel (convolution kernel) is carried out, and then the features are extracted by combining the batch normalization layer and ReLU layer. Because each output channel contains several small spatial regions that need to be refined, the whole output is a collection of these regions, and then the depth of 3×3 convolution is expanded to extract semantic information from these regions. Then the semantic residuals obtained from BN layer are used to further analyze the semantic information from regional features, then all branch feature maps are connected, and all feature maps are merged by pointwise convolution to generate a final residual corresponding to the input feature map. Finally, the final residual and the input feature map are fused to construct a stronger and more comprehensive feature representation.

In an exemplary embodiment, the fused dilation-wise residual module is provided with several channels, in which the number of convolution channels with the lowest void rate is set to be twice that of other channels.

In practical application, no matter what the stage, the features extracted with small receptive field are relatively important, so the number of convolution channels with the lowest void rate is set to be twice that of other channels.

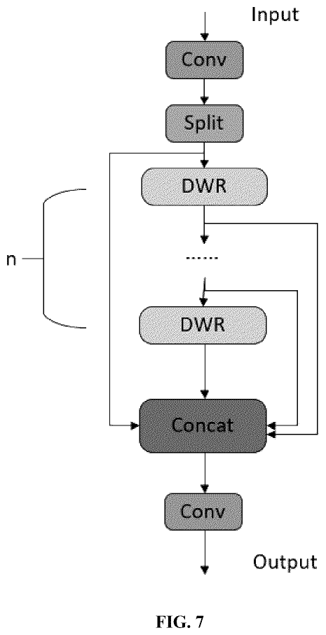

FIG. 7 is a sixth structural diagram of the weed detection model provided by an embodiment of the present disclosure.

In an exemplary embodiment, inspired by DWR module, the C2fDWR module is further designed in this embodiment, and its structural diagram is shown in FIG. 7. In order to make up for the deficiency of the model in occlusion target recognition, the designed C2fDWR module in this embodiment replaces the C2f module of the backbone RevCol to further improve the performance of the model.

In an exemplary embodiment, the GSConv module is used for:
based on a number of input channels, obtaining a number of first output channels by standard convolution;
based on the number of first output channels, obtaining a number of second output channels by deep separable convolution;
connecting and shuffling the number of first output channels and the number of second output channels to obtain a number of output channels.

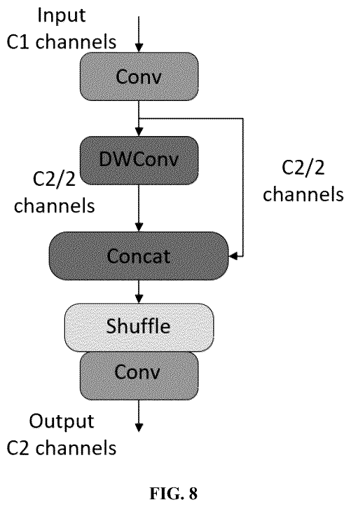

FIG. 8 is a seventh structural diagram of the weed detection model provided by an embodiment of the present disclosure.

In practical application, in order to make the model more suitable for edge terminal equipment, lightweight design is essential. Lightweight model cannot only reduce the cost of computing resources of the model, but also improve the detection speed of the model. In the embodiment, depth separable convolution is used to replace the traditional convolution module. Different from the traditional convolution mode, depth separable convolution layers the feature layers of the input channels, which can effectively reduce the problem of large amount of calculation in multi-channels. However, the information between channels lost in the conventional depth separable convolution still exists. Therefore, this disclosure introduces a GSConv lightweight convolution module based on depth separable convolution, and its main structure is shown in FIG. 7. The number of input channels is C1, and the number of output channels is C2. Firstly, based on the number of input channels C1, the first output channel number is obtained through a standard convolution, and then the same number of channels, namely the second output channel number, is obtained through depth separable convolution. Finally, the final output channel number can be obtained by Concat connection and shuffling of the two results, that is to say, both the first output channel number and the second output channel number are equivalent to half of the final output channel number.

In this embodiment, the multi-channel information can be well preserved by GSConv, and the expression ability of image features can be improved while reducing computing resources.

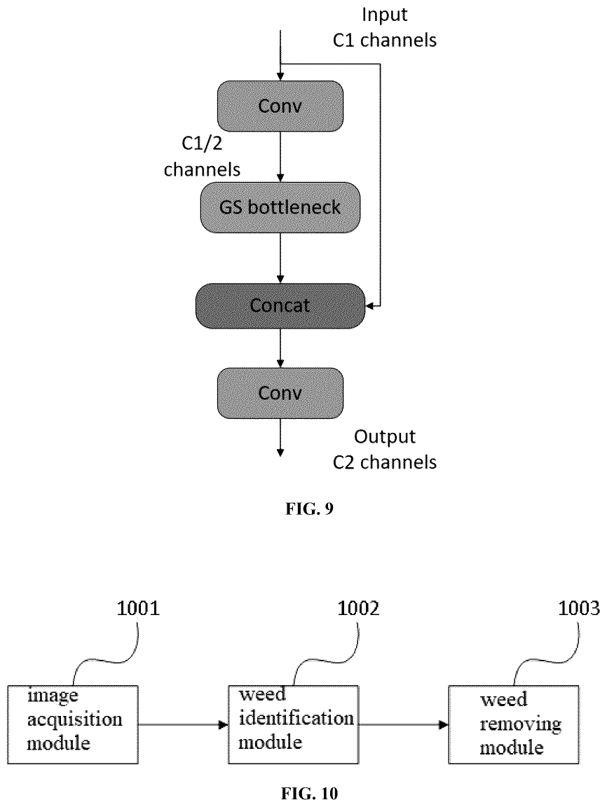

FIG. 9 is an eighth structural diagram of the weed detection model provided by an embodiment of the present disclosure.

In an exemplary embodiment, FIG. 9 illustrates the structure of a VoV-GSCSPC module. In the embodiment, it is disclosed that the GSConv module can be introduced into the Neck layer, and the standard convolution can be replaced by GSConv to reduce the parameters and calculations of the neck module, and the CSP module of the original model can be replaced by VoV-GSC SPC, a VOV cross-stage partial network module based on GSConv and lightweight bottleneck layer GSbottleneck, so that the performance of YOLOv8 can be further improved.

In an exemplary embodiment, improving a bounding box regression loss function of YOLOv8 model based on a minimum point distance includes:
determining a similarity between a predicted bounding box and an actual labeled bounding box in a process of bounding box regression, and calculating a key point distance between the predicted bounding box and the actual labeled bounding box based on the similarity, so as to improve an accuracy of loss measurement.

In practical application, the bounding box regression loss function used in YOLOv8 model is CIou loss, which takes the aspect ratio of bounding box into account in the loss function on the basis of DIou, further improving the accuracy of regression, but most BBR loss functions represented by CIou may have the same value under different prediction results, which reduces the convergence speed and accuracy of bounding box regression. In view of this, a new loss function MPDIou based on the minimum point distance is introduced into this embodiment as the loss function of the improved YOLOv8 model, and the similarity between the predicted bounding box and the actual labeled bounding box in the process of bounding box regression is compared, and a more accurate loss measurement method is provided by directly calculating the key point distance between the predicted frame and the real frame. Specifically, the calculation formula of the loss function provided in this embodiment is as follows:

$${d}_{1}^{2} = {( {x}_{1}^{B} - {x}_{1}^{A} )}^{2} + {( {y}_{1}^{B} - {y}_{1}^{A} )}^{2}$$

$${d}_{2}^{2} = {( {x}_{2}^{B} - {x}_{2}^{A} )}^{2} + {( {y}_{2}^{B} - {y}_{2}^{A} )}^{2}$$

$$MPDIoU = IoU - \frac{{d}_{1}^{2}}{{w}^{2} + {h}^{2}} - \frac{{d}_{2}^{2}}{{w}^{2} + {h}^{2}}$$

$$LMPDloU = 1 - MPDIoU$$

Where A and B are the predicted frame and the real frame respectively, w and h respectively represent the width and height of the input image, and

$$( {x}_{1}^{A} , {y}_{1}^{A} ) and ( {x}_{2}^{A} , {y}_{2}^{A} )$$

are the coordinates of the upper left corner point of A and the lower right corner point of A respectively, and

$$( {x}_{1}^{B} , {y}_{1}^{B} ) and ( {x}_{2}^{B} , {y}_{2}^{B} )$$

are the coordinates of the upper left corner point and the lower right corner point of B respectively.

In an exemplary embodiment, improving a bounding box regression loss function of YOLOv8 model includes:
introducing a scale factor “ratio” to control a size of an auxiliary frame to calculate a loss;
when a value of ratio is set to be greater than 1, generating a larger scale auxiliary frame relative to the actual frame to calculate the loss;
when the value of ratio is set to less than 1, generating a smaller scale auxiliary frame to calculate the loss, so that an absolute value of a regression gradient is greater than that of an actual frame IoU gradient.

In practical application, the embodiment can further add Inner IoU to the above-mentioned loss function MPDIou, and propose a new loss function InnerMPDIou as the model bounding box regression loss function. Specifically, Inner IoU is different from the traditional improved method. It can effectively accelerate the border regression by analyzing the loss calculated by using auxiliary borders with different scales in the regression process. Inner IoU introduces a scale factor “ratio” to control the size of the auxiliary borders to calculate the loss. Usually, the range of the scale factor “ratio” is [0.5, 1.5]. When the value of the “ratio” is set to be greater than 1, the calculation loss of auxiliary frame with a larger scale relative to the actual frame will be generated, which can expand the effective range of regression, and has a certain gain for the regression of lower IoU samples. When the value of “ratio” is set to less than 1, the calculation loss of auxiliary frame with a smaller scale will be generated, which can make the absolute value of regression gradient greater than that of actual frame IoU gradient, which is helpful for the regression of high IoU samples and has the effect of accelerating convergence. Inner MPDIoU is calculated as follows:

$${b}_{l}^{gt} = {x}_{c}^{gt} - \frac{{w}^{gt} * ratio}{2}$$

$${b}_{r}^{gt} = {x}_{c}^{gt} + \frac{{w}^{gt} * ratio}{2}$$

$${b}_{t}^{gt} = {y}_{c}^{gt} - \frac{{h}^{gt} * ratio}{2}$$

$${b}_{b}^{gt} = {y}_{c}^{gt} + \frac{{h}^{gt} * ratio}{2}$$

$${b}_{l} = {x}_{c} - \frac{w * ratio}{2}$$

$${b}_{r} = {x}_{c} + \frac{w * ratio}{2}$$

$${b}_{t} = {y}_{c} - \frac{h * ratio}{2}$$

$${b}_{b} = {y}_{c} + \frac{h * ratio}{2}$$

$$inter = ( min ( {b}_{r}^{gt} , {b}_{r} ) - max ( {b}_{l}^{gt} , {b}_{l} ) ) * ( min ( {b}_{b}^{gt} , {b}_{b} ) - max ( {b}_{t}^{gt} , {b}_{t} ) )$$

$$union = ( {w}^{gt} * {h}^{gt} ) * {( ratio )}^{2} + ( w * h ) * {( ratio )}^{2} - inter$$

$${IoU}^{inner} = \frac{inter}{union}$$

$${L}_{InnerMPDIoU} = {L}_{MPDIoU} + IoU - {IoU}^{inner}$$

On weed25 data set, compared with YOLOv8, the improved model proposed in this disclosure reduces the computational complexity by 35.8%, the parameter quantity by 35.36%, and the model size by 30.15%. At the same time, the mAP50 value and mAP50-95 value are increased to 93.8% and 63.4% respectively, and the accuracy value is increased to 92.9%. The performance of the improved model is superior to the original one in many aspects.

Hereinafter, the farmland weed detection system provided by the present disclosure will be described, and the farmland weed detection system described below and the farmland weed detection method described above can refer to each other correspondingly.

FIG. 10 is a schematic structural diagram of a farmland weed detection system provided by an embodiment of the present disclosure.

As shown in FIG. 10, the farmland weed detection system provided by this embodiment includes:
an image acquisition module 1001, configured for collecting a target image of weeds in farmland;
a weed identification module 1002, configured for constructing a weed detection model by using YOLOv8 based on a RevColNet backbone network, and identifying weeds based on the weed detection model;
a weed removing module 1003, configured for accurately removing the weeds.

The specific implementation method of the farmland weed detection system provided by this embodiment can be implemented with reference to the above embodiment, and will not be described here.

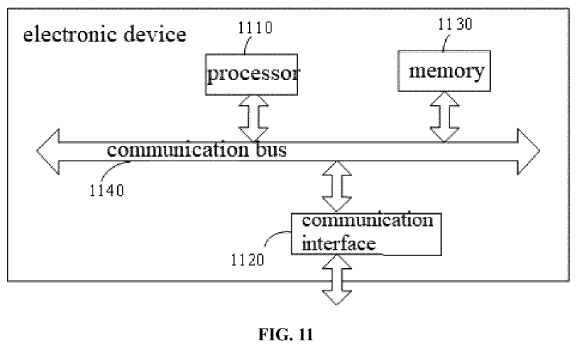

FIG. 11 illustrates the physical structure of an electronic device. As shown in FIG. 11, the electronic device may include a processor 1110, a communication interface 1120, a memory 1030 and a communication bus 1140, wherein the processor 1110, the communication interface 1120 and the memory 1130 communicate with each other through the communication bus 1140. The processor 1110 can call the logical instructions in the memory 1130 to execute a method for detecting weeds in farmland, which includes:
collecting a target image of weeds in farmland;
constructing a weed detection model by using YOLOv8 based on a RevColNet backbone network, and identifying weeds based on the weed detection model;
accurately removing the weeds.

The weed detection model is obtained by the following methods:
reconstructing a backbone network of YOLOv8 based on the RevColNet, and obtaining a backbone network RevCol;
introducing a fused dilation-wise residual module to improve a recognition ability of occluded targets;
introducing a GSConv module and a VoV-GSCSPC module that are based on deep separable convolution to lighten the model;
improving a bounding box regression loss function of YOLOv8 model based on a minimum point distance.

In addition, the above-mentioned logical instructions in the memory 1130 can be realized in the form of software functional units and can be stored in a computer-readable storage medium when they are sold or used as independent products. Based on this understanding, the technical solution of the present disclosure can be embodied in the form of a software product, which is stored in a storage medium and includes several instructions to make a computer device (which can be a personal computer, a server, a network device, etc.) execute all or part of the steps of the methods of various embodiments of the present disclosure. The aforementioned storage media include: U disk, mobile hard disk, Read-Only Memory (ROM), Random Access Memory (RAM), magnetic disk or optical disk and other media that can store program codes.

On the other hand, the disclosure also provides a computer program product, which includes a computer program, the computer program can be stored on a non-transient computer-readable storage medium, and when the computer program is executed by a processor, the computer can execute the methods for detecting weeds in farmland provided by the above methods, and the method includes the following:
collecting a target image of weeds in farmland;
constructing a weed detection model by using YOLOv8 based on a RevColNet backbone network, and identifying weeds based on the weed detection model;
accurately removing the weeds.

The weed detection model is obtained by the following methods:
reconstructing a backbone network of YOLOv8 based on the RevColNet, and obtaining a backbone network RevCol;
introducing a fused dilation-wise residual module to improve a recognition ability of occluded targets;
introducing a GSConv module and a VoV-GSCSPC module that are based on deep separable convolution to lighten the model;
improving a bounding box regression loss function of YOLOv8 model based on a minimum point distance.

On the other hand, the disclosure also provides a non-transient computer-readable storage medium, on which a computer program is stored, and the computer program, when executed by a processor, is realized to execute the methods for detecting weeds in farmland provided by the above methods, and the method includes the following:
collecting a target image of weeds in farmland;
constructing a weed detection model by using YOLOv8 based on a RevColNet backbone network, and identifying weeds based on the weed detection model; accurately removing the weeds.

The weed detection model is obtained by the following methods:
reconstructing a backbone network of YOLOv8 based on the RevColNet, and obtaining a backbone network RevCol;
introducing a fused dilation-wise residual module to improve a recognition ability of occluded targets;
introducing a GSConv module and a VoV-GSCSPC module that are based on deep separable convolution to lighten the model;
improving a bounding box regression loss function of YOLOv8 model based on a minimum point distance.

The device embodiments described above are only schematic, in which the units described as separate components may or may not be physically separated, and the components displayed as units may or may not be physical units, that is, they may be located in one place or distributed to multiple network units. Some or all of the modules can be selected according to actual needs to achieve the purpose of this embodiment. Ordinary technicians in this field can understand and implement it without creative labor.

From the description of the above embodiments, those skilled in the art can clearly understand that each embodiment can be realized by means of software and necessary general hardware platform, and of course it can also be realized by hardware. Based on this understanding, the essence of the above technical scheme or the part that has contributed to the prior art can be embodied in the form of a software product, which can be stored in a computer-readable storage medium, such as ROM/RAM, magnetic disk, optical disk, etc., and includes several instructions to make a computer device (which can be a personal computer, a server, or a network device, etc.) execute the methods of various embodiments or some parts of embodiments.

Finally, it should be explained that the above embodiments are only used to illustrate the technical scheme of the present disclosure, but not to limit it; Although the present disclosure has been described in detail with reference to the foregoing embodiments, those skilled in the art should understand that it is still possible to modify the technical solutions described in the foregoing embodiments, or to replace some technical features with equivalents; However, these modifications or substitutions do not make the essence of the corresponding technical solutions deviate from the spirit and scope of the technical solutions of various embodiments of the present disclosure.

What is claimed is:

1. A method for detecting weeds in a farmland, comprising:
collecting a target image of the weeds in the farmland;
constructing a weed detection model by using a YOLOv8 based on a RevColNet backbone network, and identifying the weeds based on the weed detection model; and
accurately removing the weeds.

2. The method for detecting the weeds in the farmland according to claim 1, wherein using the YOLOv8 based on the RevColNet backbone network to construct the weed detection model comprises:
reconstructing a backbone network of the YOLOv8 based on the RevColNet backbone network, and obtaining a backbone network RevCol;
introducing a fused dilation-wise residual module to improve a recognition ability of occluded targets;
introducing a GSConv module and a VoV-GSCSPC module to lighten the weed detection model, wherein the GSConv module and the VoV-GSCSPC module are based on a deep separable convolution; and
improving a bounding box regression loss function of a YOLOv8 model based on a minimum point distance.

3. The method for detecting the weeds in the farmland according to claim 2, wherein the backbone network RevCol comprises a plurality of columns, wherein each column represents an input, a starting position of each column contains a low-level detail information, and with a compression of image channels, a high-level semantic information is extracted at an end position of each column; a reversible connection design is adopted between the columns to ensure that information is transmitted between the columns without a loss, and a supervision is added at the end position of each column to constrain a feature extraction of each column.

4. The method for detecting the weeds in the farmland according to claim 2, wherein the fused dilation-wise residual module is used for:
performing a 3×3 standard convolution operation on data input into the weed detection model, and extracting features through a batch normalization and an activation by using an activation function;
after the 3×3 standard convolution operation, obtaining a semantic residual through a BN layer;
connecting all branches to characteristic graphs, merging all the characteristic graphs by a pointwise convolution, and generating a final residual corresponding to the data input into the weed detection model; and
fusing the final residual with input data to construct a final feature representation.

5. The method for detecting the weeds in the farmland according to claim 4, wherein the fused dilation-wise residual module is provided with a plurality of channels, and a number of convolution channels with a lowest void rate is set to be twice a number of other channels.

6. The method for detecting the weeds in the farmland according to claim 2, wherein the GSConv module is used for:
based on a number of input channels, obtaining a number of first output channels by a standard convolution;
based on the number of the first output channels, obtaining a number of second output channels by the deep separable convolution; and
connecting and shuffling the number of the first output channels and the number of the second output channels to obtain a number of output channels.

7. The method for detecting the weeds in the farmland according to claim 2, wherein improving the bounding box regression loss function of the YOLOv8 model based on the minimum point distance comprises:
determining a similarity between a predicted bounding box and an actual labeled bounding box in a process of bounding box regression, and calculating a key point distance between the predicted bounding box and the actual labeled bounding box based on the similarity to improve an accuracy of loss measurement.

8. The method for detecting the weeds in the farmland according to claim 7, wherein improving the bounding box regression loss function of the YOLOv8 model comprises:
introducing a scale factor to control a size of an auxiliary frame to calculate a loss, wherein the scale factor is defined as a ratio;
when a value of the ratio is set to be greater than 1, generating a larger scale auxiliary frame relative to an actual frame to calculate the loss; and
when the value of the ratio is set to be less than 1, generating a smaller scale auxiliary frame relative to the actual frame to calculate the loss, wherein an absolute value of a regression gradient is greater than an absolute value of an actual frame IoU gradient.

9. A system for detecting weeds in a farmland, comprising:
an image acquisition module, configured for collecting a target image of the weeds in the farmland;
a weed identification module, configured for constructing a weed detection model by using a YOLOv8 based on a RevColNet backbone network, and identifying the weeds based on the weed detection model; and
a weed removing module, configured for accurately removing the weeds.

10. An electronic device, comprising a memory, a processor, and a computer program stored in the memory and executable on the processor, wherein when the processor executes the computer program, the method for detecting the weeds in the farmland according to claim 1 is realized.
